(19) United States
(12) Patent Application Publication
(10) Pub. No.: US 2026/0328118 A1
(43) Pub. Date: Oct. 22, 2026

(54) INERT GAS SUMP PRESSURIZATION SYSTEM AND METHOD FOR A TURBINE ENGINE

(71) Applicant: General Electric Company, Evendale, OH (US)

(72) Inventors: Andrew Gumpert, West Chester Township, OH (US); Kevin Leslie, Cincinnati, OH (US)

(21) Appl. No.: 19/180,623

(22) Filed: Apr. 16, 2025

(51) Int. Cl. F01D 25/18; B64D 27/10; F01D 25/20; F01D 25/22

(52) U.S. Cl. CPC F01D 25/183; B64D 27/10; F01D 25/18; F01D 25/20; F01D 25/22; F05D 2260/98

(57) ABSTRACT

A turbine engine for an aircraft includes a fan section, a turbo-engine that includes a compressor and defines a core air flow path therethrough, a sump defined by at least one of the turbo-engine or the fan section, a sump seal assembly that forms a sump seal between the sump and a void area of the turbine engine adjacent to the sump, and a sump pressurization system. The sump pressurization system includes an inert gas source that provides an inert gas under positive pressure and is arranged to route the inert gas from the inert gas source to the sump seal assembly, the void area, or both, to pressurize the sump.

### TECHNICAL FIELD

The present disclosure generally relates to a turbine engine, and, more particularly, to a sump pressurization system for a turbine engine of an aircraft.

### BACKGROUND

Turbine engines, for example, for an aircraft, generally include a fan section and a turbo-engine arranged in flow communication with one another. Bearings are provided in the fan section and the turbo-engine for supporting various rotary components of the turbine engine. The turbine engine further includes one or more sumps enclosing the bearings, to contain lubrication oil therein during operation of the turbine engine. Some turbine engines provide pressurized air around the sumps to contain the lubrication oil within the sumps.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic view of an aircraft having a sump pressurization system, according to the present disclosure.

FIG. 2 is a schematic, cross-sectional view of a turbine engine of the aircraft shown in FIG. 1, taken along a longitudinal centerline axis of the turbine engine, according to the present disclosure.

FIG. 3 is an enlarged, partial, schematic cross-sectional diagram of the turbine engine shown in FIG. 2, taken at the detail area labeled “3” in FIG. 2.

FIG. 4 is a schematic diagram of the sump pressurization system and the turbine engine of the aircraft shown in FIG. 1, according to the present disclosure.

FIG. 5 is a schematic diagram of the turbine engine shown in FIG. 4, according to the present disclosure.

FIG. 6 is a schematic diagram of a sump of a plurality of sumps of the turbine engine shown in FIG. 5, according to the present disclosure.

FIG. 7 is a schematic diagram of a sump pressurization system and a turbine engine of the aircraft shown in FIG. 1, according to another embodiment of the present disclosure.

FIG. 8 is a schematic diagram of a sump pressurization system and a turbine engine of the aircraft shown in FIG. 1, according to another embodiment of the present disclosure.

FIG. 9 is a flowchart showing a method of pressurizing a sump of a turbine engine of an aircraft, such as the aircraft of FIG. 1, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” “fourth,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and are based on a normal operational attitude of the turbine engine or vehicle. More particularly, forward and aft are used herein with reference to a direction of travel of the vehicle and a direction of propulsive thrust of the turbine engine. For example, with regard to a turbine engine, forward refers to a position closer to an engine inlet and aft refers to a position closer to an engine nozzle or an exhaust.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a longitudinal centerline axis of the turbine engine. Moreover, the terms “radial” and “radially” refer to directions and orientations that extend substantially perpendicular to the longitudinal centerline axis of the turbine engine. In addition, as used herein, the terms “circumferential” and “circumferentially” refer to directions and orientations that extend arcuately about the longitudinal centerline axis of the turbine engine.

The terms “inert gas,” “inert air,” or the like, as used herein with reference to a sump pressurization system, refer to a gas that is substantially or entirely free of reactive gases, such as oxygen. An inert gas may be a noble gas or a substantially non-reactive gas. Although a variety of inert gases may be utilized in the disclosed embodiments, particular examples of an inert gas include, but are not limited to, nitrogen, carbon dioxide, helium, neon, argon, krypton, xenon, radon, or any combination thereof. In some examples, an inert gas is preferably nitrogen. In some examples, an inert gas may be inert nitrogen enriched air.

Approximating language, as used herein throughout the specification and claims, is applied to modify any quantitative representation that could permissibly vary without resulting in a change in the basic function to which it is related. Accordingly, a value modified by a term or terms, such as “about” and “substantially” is not to be limited to the precise value specified. In at least some instances, the approximating language may correspond to the precision of an instrument for measuring the value, or the precision of the methods, or the machines for constructing the components, and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Turbine engines, such as turbine engines for aircraft, generally include a fan section and a turbo-engine arranged in flow communication with one another. The turbo-engine generally includes, in serial flow order, a compressor section, a combustion section, a turbine section, and an exhaust section. In operation, air is provided from a fan of the fan section to an inlet of the compressor section where one or more axial compressors progressively compress the air until the compressed air reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Within the turbo-engine, various bearings are provided for supporting various rotary components of the turbine engine. Typically, these bearings are oil lubricated bearings, such that an engine oil system provides lubrication oil thereto during operation of the turbine engine. Accordingly, the turbine engine may include one or more sumps enclosing such bearings via various sump seals, to contain lubrication oil provided thereto. Further, various seals and drives of the fan section and the turbo-engine may also be contained within the one or more sumps of the turbine engine.

In order to better contain such lubrication oil within the sumps, some conventional sump pressurization systems of turbine engines provide pressurized air to void regions around the sumps. In other conventional sump pressurization systems, pressurized air may be provided directly to the sump seals surrounding the sumps to effectuate a seal provided by the sump seals. In either example of conventional sump pressurization systems, compressed atmospheric air is bled from within the compressor section to the void regions or to the sump seal. However, pulling compressed air from the compressor section may result in a parasitic loss, i.e., using a portion of the compressed air for other engine functions that would otherwise be supplied to the combustor section, resulting in decreased efficiency of the turbine engine. Further, some of the compressed atmospheric air provided to the void regions may enter the sump environment and mix with the lubrication oil, which may result in time and temperature dependent depletion of oil antioxidants that are designed to prevent oil degradation and coking deposits.

Moreover, such conventional sump pressurization systems of turbine engines are reliant on condition dependent engine bleeds and can be specifically sensitive at idle conditions of the turbine engine, e.g., at ground idle and flight idle. For this reason, conventional sump pressurization systems commonly require an air eductor, e.g., a jet pump or a venturi pump. During idle conditions of the turbine engine, the air eductor reduces the sump pressurization (e.g., to an ambient pressure within the sump) to maintain a positive pressure differential across the sump seals in order to prevent oil from leaking out of the sumps. Including an air eductor on a turbine engine, however, adds to the complexity of the turbine engine assembly and may increase an overall weight of the turbine engine, which can reduce operational performance of the turbine engine.

Accordingly, the present disclosure provides for an improved sump pressurization system for an aircraft having at least one turbine engine that provides an inert gas to pressurize the sumps of the turbine engine and that can be operated to maintain sump pressurization throughout the various operating conditions of the turbine engine. Particularly, embodiments of the present disclosure can provide for a sump pressurization system that is not reliant on condition dependent engine bleeds, which can provide for a less complex turbine engine system with improved operational performance, and that utilizes an onboard inert gas source to pressurize the sumps of the turbine engine, which can extend the life of the lubrication oils used in the sumps of the turbine engine that can enable the sump environment to run at higher temperatures and for longer durations with reduced oil degradation or coking deposits.

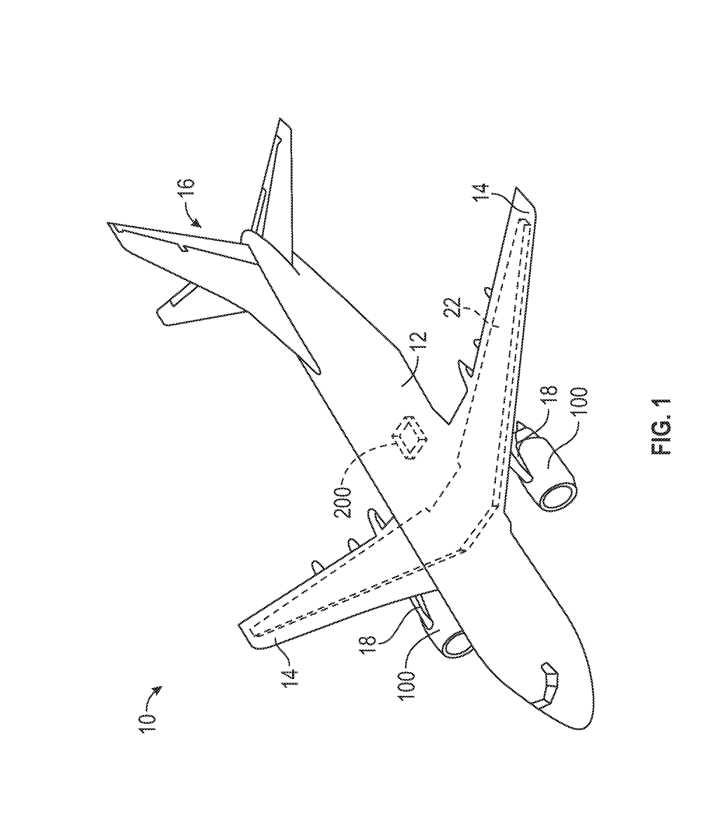

Referring now to the drawings, FIG. 1 shows an aircraft 10 that may implement various embodiments of the present disclosure. In the illustrated embodiment, the aircraft 10 includes a fuselage 12, a pair of wings 14 attached to the fuselage 12, and an empennage 16. The aircraft 10 also includes a propulsion system that produces a propulsive thrust required to propel the aircraft 10 in flight, during taxiing operations, and the like. The propulsion system for the aircraft 10 shown in FIG. 1 includes a pair of turbine engines 100. In the illustrated embodiment, each turbine engine 100 is attached to one of the wings 14 by a pylon 18 in an under-wing configuration. Although the turbine engines 100 are shown attached to the respective wings 14 in an under-wing configuration in FIG. 1, in other embodiments, the turbine engine 100 may have alternative configurations and may be coupled to other portions of the aircraft 10. For example, the turbine engine 100 may additionally or alternatively include one or more aspects coupled to other parts of the aircraft 10, such as, for example, the empennage 16, and the fuselage 12.

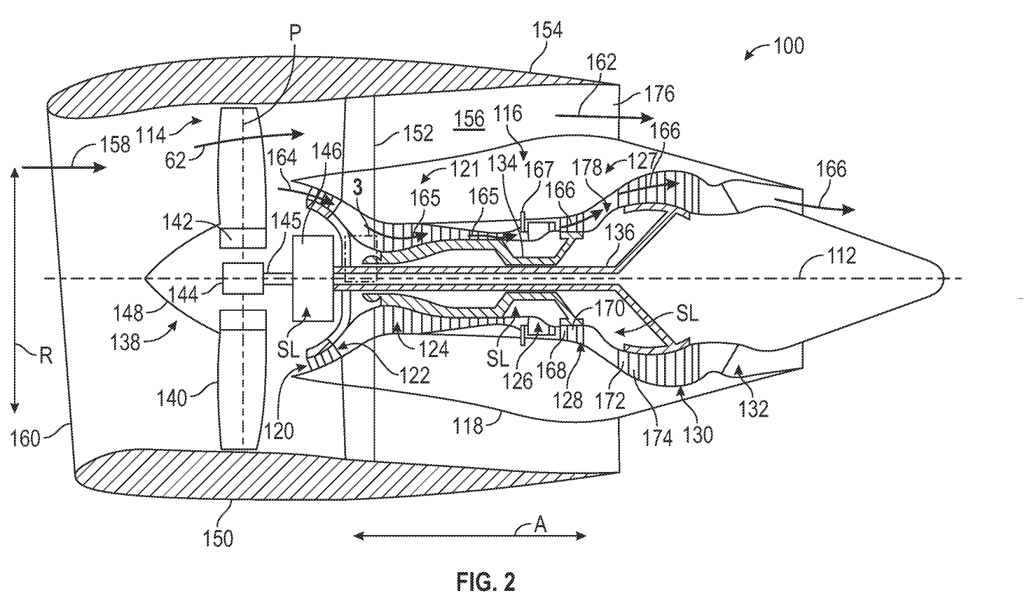

As will be described in greater detail below, with reference to FIG. 2, the turbine engines 100 shown in FIG. 1 are gas turbine engines that are each capable of selectively generating a propulsive thrust for the aircraft 10. The amount of propulsive thrust may be controlled at least in part based on a volume of fuel provided to the turbine engine 100 (e.g., a gas turbine engine) via a fuel system (not shown). An aviation turbine fuel in the embodiments discussed herein is a combustible hydrocarbon liquid fuel, such as a kerosene-type fuel, having a desired carbon number, a synthetic aviation fuel, a biofuel, a biodiesel, an ethanol, a bioalcohol, and the like. As shown in FIG. 1, the fuel is stored in a fuel tank 22 of the fuel system. Particularly, in the illustrated embodiment of FIG. 1, at least a portion of the fuel tank 22 is located in each wing 14 and another portion of the fuel tank 22 is located in the fuselage 12 between the wings 14. The fuel tank 22, however, may be located at other suitable locations in the fuselage 12 or the wing 14. The fuel tank 22 may also be located entirely within the fuselage 12 or the wing 14. In the illustrated embodiment, the fuel tank 22 is a single, unitary body extending from one wing 14 and across the fuselage 12 to the other wing 14. In other embodiments, the fuel tank 22 may include a plurality of separate tanks, such as, for example, two tanks each located within a corresponding wing 14.

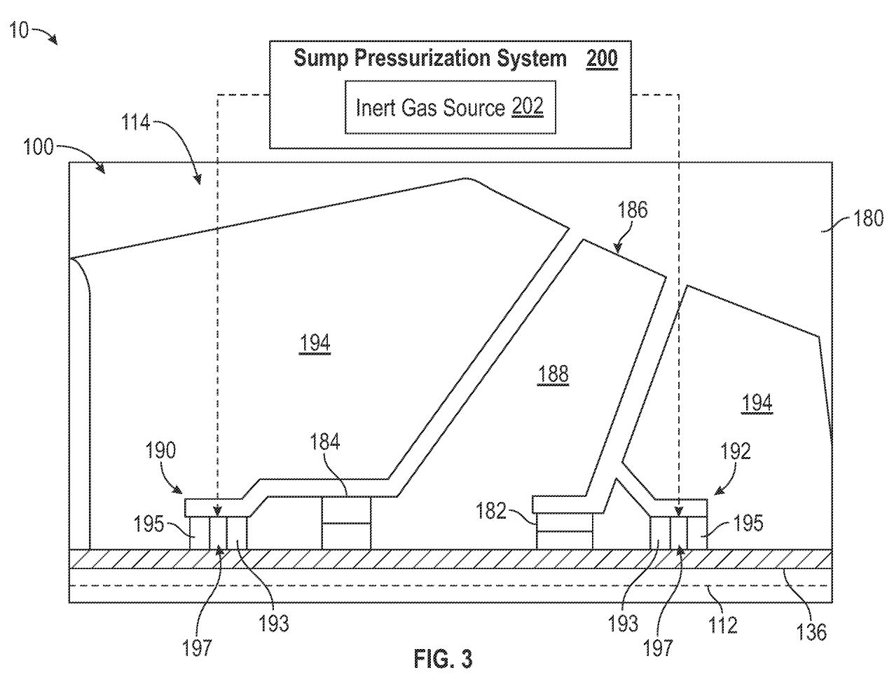

In the illustrated embodiment, the aircraft 10 further includes a sump pressurization system 200 (as indicated by a dashed box in FIG. 1). As will be described in greater detail below with reference to FIG. 3, the sump pressurization system 200 is configured to provide pressurized inert gas to pressurize sumps of the turbine engines 100. In some embodiments, the aircraft 10 can include a plurality of sump pressurization systems 200. For example, in some such embodiments, one or both of the turbine engines 100 of the aircraft 10 may include a separate sump pressurization system.

Although the aircraft 10 shown in FIG. 1 is an airplane, the embodiments described herein may also be applicable to other types of aircraft, including, for example, helicopters and unmanned aerial vehicles (UAV). The aircraft discussed herein are fixed-wing aircraft or rotor aircraft that generate lift by aerodynamic forces acting on, for example, a fixed wing (e.g., the wings 14) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 2 is a schematic, cross-sectional view of one of the turbine engines 100 of the aircraft 10 shown in FIG. 1, taken along a longitudinal centerline axis 112 of the turbine engine 100, according to an embodiment of the present disclosure. As shown in FIG. 2, the turbine engine 100 defines an axial direction A (extending parallel to the longitudinal centerline axis 112 provided for reference) and a radial direction R that is normal to the axial direction A. In general, the turbine engine 100 includes a fan section 114 and a turbo-engine 116 disposed downstream (i.e., in an aft direction of the axial direction A, opposite a forward direction thereof) from the fan section 114.

The turbo-engine 116 includes, in serial flow relationship, a compressor section 121, a combustion section 126, and a turbine section 127. The turbo-engine 116 is substantially enclosed within an outer casing 118 that is substantially tubular and defines a core inlet 120 that is annular about the longitudinal centerline axis 112. As schematically shown in FIG. 2, the compressor section 121 includes a booster or a low pressure (LP) compressor 122 followed downstream by a high pressure (HP) compressor 124. The combustion section 126 is downstream of the compressor section 121. The turbine section 127 is downstream of the combustion section 126 and includes a high pressure (HP) turbine 128 followed downstream by a low pressure (LP) turbine 130. The turbo-engine 116 further includes a jet exhaust nozzle section 132 that is downstream of the turbine section 127, a high-pressure (HP) shaft 134 or a spool, and a low-pressure (LP) shaft 136. The HP shaft 134 drivingly connects the HP turbine 128 to the HP compressor 124. The HP turbine 128 and the HP compressor 124 rotate in unison through the HP shaft 134. The LP shaft 136 drivingly connects the LP turbine 130 to the LP compressor 122. The LP turbine 130 and the LP compressor 122 rotate in unison through the LP shaft 136. The compressor section 121, the combustion section 126, the turbine section 127, and the jet exhaust nozzle section 132 together define a core air flow path.

For the embodiment depicted in FIG. 2, the fan section 114 includes a fan 138 (e.g., a variable pitch fan) having a plurality of fan blades 140 coupled to a disk 142 in a spaced apart manner. As depicted in FIG. 2, the fan blades 140 extend outwardly from the disk 142 generally along the radial direction R. In the case of a variable pitch fan, the plurality of fan blades 140 is rotatable relative to the disk 142 about a pitch axis P by virtue of the fan blades 140 being operatively coupled to an actuation member 144 configured to collectively vary the pitch of the fan blades 140 in unison. The fan blades 140, the disk 142, and the actuation member 144 are together rotatable about the longitudinal centerline axis 112 via a fan shaft 145 that is powered by the LP shaft 136 across a power gearbox, also referred to as a gearbox assembly 146. In this way, the fan 138 is drivingly coupled to, and powered by, the turbo-engine 116, and the turbine engine 100 is an indirect drive engine. The gearbox assembly 146 is shown schematically in FIG. 2. The gearbox assembly 146 is a reduction gearbox assembly for adjusting the rotational speed of the fan shaft 145 and, thus, the fan 138 relative to the LP shaft 136 when power is transferred from the LP shaft 136 to the fan shaft 145.

Referring still to the exemplary embodiment of FIG. 2, the disk 142 is covered by a fan hub 148 that is aerodynamically contoured to promote an airflow through the plurality of the fan blades 140. In addition, the fan section 114 includes an annular fan casing or a nacelle 150 that circumferentially surrounds the fan 138 and at least a portion of the turbo-engine 116. The nacelle 150 is supported relative to the turbo-engine 116 by a plurality of outlet guide vanes 152 that are circumferentially spaced about the nacelle 150 and the turbo-engine 116. Moreover, a downstream section 154 of the nacelle 150 extends over an outer portion of the turbo-engine 116, and, with the outer casing 118, defines a bypass airflow passage 156 therebetween.

During operation of the turbine engine 100, a volume of air 158 enters the turbine engine 100 through an inlet 160 of the nacelle 150 or the fan section 114. As the volume of air 158 passes across the fan blades 140, a first portion of air, also referred to as bypass air 162, is routed into the bypass airflow passage 156, and a second portion of air, also referred to as core air 164, is routed into the upstream section of the core air flow path through the core inlet 120 of the LP compressor 122. The ratio between the bypass air 162 and the core air 164 is commonly known as a bypass ratio. The pressure of the core air 164 is then increased, generating compressed air 165. The compressed air 165 is routed through the HP compressor 124 and into the combustion section 126, where the compressed air 165 is mixed with fuel 167 and ignited to generate combustion gases 166.

The combustion gases 166 are routed into the HP turbine 128 and expanded through the HP turbine 128 where a portion of thermal energy or kinetic energy from the combustion gases 166 is extracted via one or more stages of HP turbine stator vanes 168 and HP turbine rotor blades 170 that are coupled to the HP shaft 134. This causes the HP shaft 134 to rotate, thereby supporting operation of the HP compressor 124 (e.g., a self-sustaining cycle). In this way, the combustion gases 166 do work on the HP turbine 128. The combustion gases 166 are then routed into the LP turbine 130 and expanded through the LP turbine 130. Here, a second portion of the thermal energy or the kinetic energy is extracted from the combustion gases 166 via one or more stages of LP turbine stator vanes 172 and LP turbine rotor blades 174 that are coupled to the LP shaft 136. This causes the LP shaft 136 to rotate, thereby supporting operation of the LP compressor 122 (e.g., a self-sustaining cycle) and rotation of the fan 138 via the gearbox assembly 146. In this way, the combustion gases 166 do work on the LP turbine 130.

The combustion gases 166 are subsequently routed through the jet exhaust nozzle section 132 of the turbo-engine 116 to provide propulsive thrust. Simultaneously, the bypass air 162 is routed through the bypass airflow passage 156 before being exhausted from a fan nozzle exhaust section 176 of the turbine engine 100, also providing propulsive thrust. The HP turbine 128, the LP turbine 130, and the jet exhaust nozzle section 132 at least partially define a hot gas path 178 for routing the combustion gases 166 through the turbo-engine 116.

FIG. 3 is an enlarged, partial, schematic cross-sectional diagram of the turbine engine 100, taken at the detail area labeled “3” in FIG. 2, according to the present disclosure. As shown in FIG. 3, the turbine engine 100 includes a frame 180 that supports certain rotary components of the fan section 114 and the turbo-engine 116 (FIG. 2), e.g., the LP shaft 136, through one or more bearing assemblies. For example, the turbine engine 100 depicted includes a first bearing 182 supporting a first portion of the LP shaft 136 and a second bearing 184 supporting a second portion of the LP shaft 136 extending to the gearbox assembly 146. The first bearing 182 and the second bearing 184 may be configured in any suitable manner for supporting the various rotary components of the turbine engine 100. For example, at least one of the first bearing 182 or the second bearing 184 may be configured as roller bearings, ball bearings, gas bearings, etc. Moreover, the exemplary bearing configuration depicted in FIG. 3 is provided by way of example only, and that, in other exemplary embodiments, the turbine engine 100 may have any other suitable bearing configuration and may utilize any other suitable type or form of bearing.

Each of the first bearing 182 and the second bearing 184 is configured as oil lubricated bearings. Accordingly, during operation of the turbine engine 100, an engine oil system (not shown) of the turbine engine 100 may provide one or both of the first bearing 182 and the second bearing 184 with lubrication oil in order to lubricate the first bearing 182 and the second bearing 184, and to remove an amount of heat from the first bearing 182 and the second bearing 184. In order to prevent the lubrication oil from reaching undesirable locations within the turbine engine 100, or the turbo-engine 116 thereof, one or both of the first bearing 182 or the second bearing 184 may be positioned within one or more sumps of a plurality sumps 186 defined by the turbine engine 100. For example, in the illustrated embodiment, the plurality of sumps 186 of the turbine engine 100 includes at least a first sump 188 enclosing each of the first bearing 182 and the second bearing 184. More specifically, the first sump 188 is defined by turbo-engine 116 (FIG. 2) of the turbine engine 100.

The plurality of sumps 186 of the turbine engine 100 may be disposed at various locations throughout the turbine engine 100, e.g., at any one or more locations containing an oil wetted bearing, seal, or drive of the turbine engine 100. By way of example, various sump locations (SL) of FIG. 2 provide example locations of one or more sumps of the plurality of sumps 186 of the turbine engine 100 in addition to, or alternative to, the location of the first sump 188 illustrated in FIG. 3. In some embodiments, the plurality of sumps 186 of the turbine engine 100 may include at least two sumps. For example, in some such embodiments, the plurality of sumps 186 of the turbine engine 100 may include a first or forward sump and a second or aft sump that is located aft of the forward sump. In some embodiments, the plurality of sumps 186 of the turbine engine 100 may include at least three sumps. For example, in some such embodiments, the plurality of sumps 186 of the turbine engine 100 may include a first or forward sump, a second or mid sump that is located aft of the forward sump, and a third or aft sump that is located aft of the mid sump. In some embodiments, at least one of the plurality of sumps 186 of the turbine engine 100 may be defined by the fan section 114 (FIG. 2). For example, in some such embodiments, the at least one of the plurality of sumps 186 may be defined by the gearbox assembly 146 (FIG. 2) of the fan section 114.

In some embodiments, the plurality of sumps 186 of the turbine engine 100 may be fluidly connected to each other. For example, in some such embodiments, the plurality of sumps 186 of the turbine engine 100 may include a first or forward sump, a second or mid sump that is fluidly connected to the forward sump, and a third or aft sump that is fluidly connected to the mid sump.

The sump pressurization system 200 of the aircraft 10 (FIG. 1) pressurizes the plurality of sumps 186 of the turbine engine 100. Particularly, the sump pressurization system 200 is configured to route a flow of pressurized inert air from an inert gas source 202 to one or more locations within the turbine engine 100, or the turbo-engine 116 thereof, to pressurize the plurality of sumps 186. For example, in the illustrated embodiment of FIG. 3, the sump pressurization system 200 is configured to provide pressurized inert air to a first or forward sump seal assembly 190 and a second or aft sump seal assembly 192 disposed between the first sump 188. Particularly, each of the first sump seal assembly 190 and the second sump seal assembly 192 includes an inner seal member 193 adjacent to the sump 188, an outer seal member 195 opposite the inner seal member 193, and a seal cavity buffer 197 defined between the inner seal member 193 and the outer seal member 195. The sump pressurization system 200 is configured to provide pressurized inert air to the seal cavity buffers 197 of the first sump seal assembly 190 and the second sump seal assembly 192.

As will be discussed in more detail below, by providing pressurized inert air to the seal cavity buffers 197 of the first sump seal assembly 190 and the second sump seal assembly 192, the first sump seal assembly 190 and the second sump seal assembly 192 may more effectively prevent lubrication oil within the first sump 188 from leaking therethrough other undesired parts of the turbine engine 100.

In some embodiments, the sump pressurization system 200 may be configured to provide pressurized inert air, via the inert gas source 202, to one or more void areas 194 surrounding the one or more sumps 186, e.g., the first sump 188. By increasing air pressure in these void areas 194, the first sump seal assembly 190 and the second sump seal assembly 192 of the first sump 188 may more effectively prevent lubrication oil from leaking therethrough, as a pressure difference across the each of the first sump seal assembly 190 and the second sump seal assembly 192 urges an airflow into the first sump 188, as opposed to lubrication oil out of the first sump 188. In some embodiments, the sump pressurization system 200 may be configured to provide pressurized inert air to each of the first sump seal assembly 190, the second sump seal assembly 192, and one or more void areas of the plurality of void areas 194.

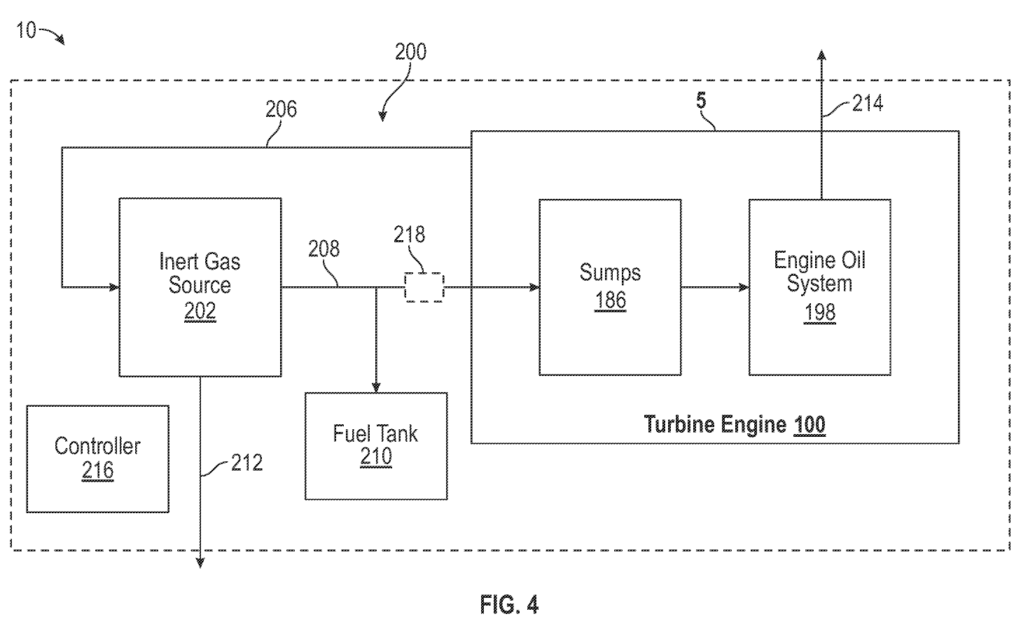

As described below in more detail with reference to FIGS. 4 to 6, the sump pressurization system 200, including the inert gas source 202 thereof, may be variously configured and implemented. In some embodiments, the inert gas source 202 of the sump pressurization system 200 may be an inert gas generating system (IGGS) that generates inert gas from, for example, engine bleed air that is selectively supplied from the turbine engine 100, or may be a stand-alone source of inert gas, such as an inert gas storage tank or one or more inert gas bottles.

The inert gas provided by the inert gas source 202 of the sump pressurization system 200 may be described as an oxygen-free or substantially oxygen-free gas, which may be a noble gas or a substantially non-reactive gas. Examples of the inert gas provided by the inert gas source 202 include, but are not limited to, nitrogen, carbon dioxide, helium, neon, argon, krypton, xenon, radon, or any combination thereof, or any combination thereof.

The use of an inert gas for pressurizing the sumps 186 of the turbine engine 100 may provide several advantages compared to other fluids, such as air. For example, inert gas may be used in certain applications in which a low concentration of oxygen is desired, e.g., inert gas may be utilized to prevent explosions of fuel contained in a fuel tank of the aircraft 10. Compared to air, the inert gas includes little to no oxygen. Thus, use of the inert gas for pressurizing the sump seal assemblies, e.g., the first sump seal assembly 190 and the second sump seal assembly 192 of FIG. 3, of the turbine engine 100 may introduce little to no oxygen to the sumps 186 containing oils or lubricants therein, e.g., the sump 188 of FIG. 3. During operation of the turbine engine 100, the inert gas may come in contact with the oils or lubricants, and compared to air, the inert gas may cause little to no degradation of the oils or lubricants. In other words, the inert gas is generally non-reactive with the oils or lubricants. Thus, use of the inert gas for pressurizing the sumps 186 may extend the life of the oils and lubricants used in the sumps 186 of the turbine engine 100. Additionally, or alternatively, less expensive oils or lubricants may be used in the sumps 186 of the turbine engine 100, as compared to turbine engines without the benefit of the present disclosure.

Moreover, as a temperature of the inert gas routed from the sump pressurization system 200 may be less than a temperature of oil within sumps 186, the inert gas may help to cool the structures and components of the turbine engine 100, e.g., the LP shaft 136 of FIG. 3. Thus, the inert gas may help to extend the life of the components and structures of the turbine engine 100, or the turbo-engine 116 thereof.

The turbine engine 100 depicted in FIGS. 2 and 3 is by way of example only. In other exemplary embodiments, the turbine engine 100 may have any other suitable configuration. For example, in other exemplary embodiments, the fan 138 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop engines, or turboshaft engines.

FIG. 4 is schematic diagram of the sump pressurization system 200 of the aircraft 10 of FIGS. 1 to 3, according to the present disclosure. As shown in FIG. 4, the sump pressurization system 200 includes the inert gas source 202 that generates the inert gas that is provided to the turbine engines 100 of the aircraft 10 (FIG. 1). More specifically, inert gas from the inert gas source 202 is provided to each of the turbine engines 100 to pressurize the plurality of sumps 186 thereof, e.g., the first sump 188 of FIG. 3. One turbine engine 100 of the aircraft 10 is shown in FIG. 4. The other turbine engine 100 of the aircraft 10 is configured similar to the illustrated turbine engine 100. For example, the other turbine engine 100 of the aircraft 10 also includes a plurality of sumps 186 that are pressurized by inert gas provided by the inert gas source 202 of the sump pressurization system 200.

In the illustrated embodiment, the inert gas source 202 is included in the aircraft 10, i.e., separate from the turbine engines 100, and, in fluid communication with the turbine engines 100 via an inert gas supply conduit 208 extending from the inert gas source 202 to each of the turbine engines 100. For example, in the illustrated embodiment, the inert gas source 202 of the sump pressurization system 200 is preferably an inert gas generating system (IGGS) that generates inert gas from, for example, engine bleed air that is selectively supplied from the turbine engine 100 via an engine bleed conduit 206 extending from the turbine engine 100 to the inert gas source 202. Some non-limiting examples of such systems include one or more of an on-board inert gas generating system (OBIGGS), a pressure swing adsorption (PSA) system, a catalytic reactor, a plurality of membranes, among others. In other embodiments, the inert gas source 202 may be a stand-alone source of inert gas, such as an inert gas storage tank or one or more inert gas bottles.

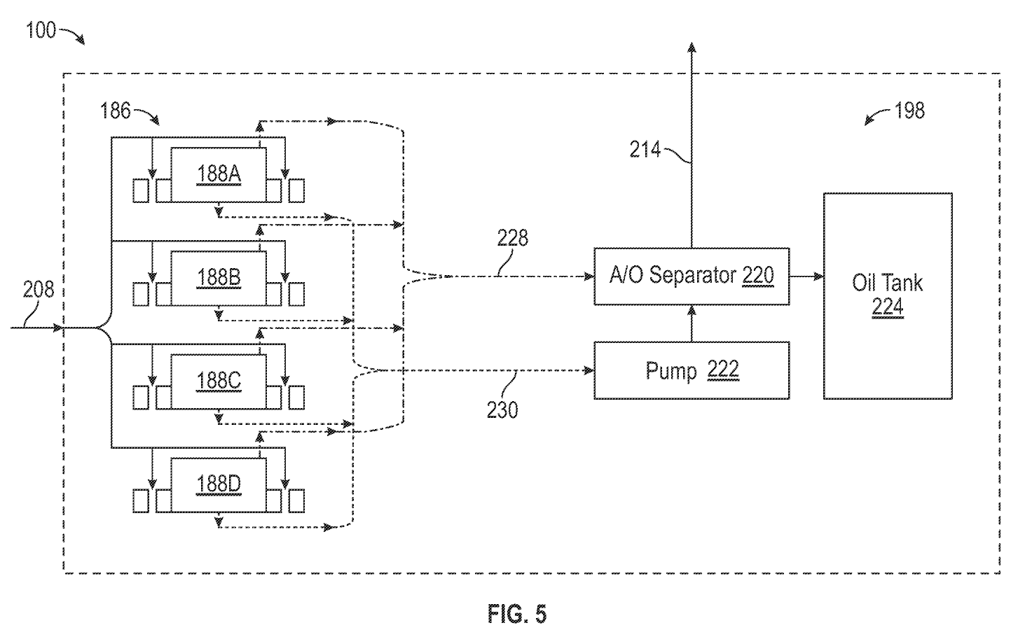

Referring still to FIG. 4, a first portion of the inert gas from the inert gas source 202 is provided to the turbine engine 100 via the inert gas supply conduit 208, while another portion of inert gas from the inert gas source 202 is provided to a fuel tank 210 of the aircraft 10, e.g., to prevent an explosion of fuel within the fuel tank 210. Exhaust gases from the inert gas source 202 may be exhausted from the aircraft 10 via an exhaust line 212. An engine oil system 198 of the turbine engine 100 provides lubrication oil to the plurality of sumps 186. As discussed in more detail below with reference to FIG. 5, the engine oil system 198 may vent reclaimed inert gas to atmosphere via an overboard vent line 214.

The sump pressurization system 200 may be configured to control flow of inert gas from the inert gas source 202 to the turbine engine 100. For example, as shown in FIG. 4, the sump pressurization system 200 can include a controller 216 and a sump pressure control valve 218 (indicated by a dashed box in FIG. 4) arranged along the inert gas supply conduit 208 between the inert gas source 202 and the plurality of sumps 186. As such, the sump pressure control valve 218 can be configured to vary a volume of flow of inert gas from the inert gas source 202 to the plurality of sumps 186, which can correspondingly vary the pressurization within of the plurality of sumps 186. For example, the controller 216 can be in electrical communication with the sump pressure control valve 218 and the controller 216 can be configured to move control a volume of flow of inert gas along the inert gas supply conduit 208 via the sump pressure control valve 218.

In some embodiments, the sump pressurization system 200 can include one or more sensors (not shown) in electrical communication with the controller 216. For example, in some such embodiments, the controller 216 may be configured to receive signals from the one or more sensors and, in response to receiving signals from the one or more sensors, adjust the pressurization of the plurality of sumps 186 via control of the sump pressure control valve 218. For example, in some embodiments, the sump pressurization system 200 can include one or more of a sensor configured to measure a total amount of inert gas at an outlet of the inert gas source 202, a sensor configured to measure a level of inert gas contained in the fuel tank 210, one or more sensors configured to measure pressures of the plurality of sumps 186 of the turbine engine 100, or a sensor arranged along the engine bleed conduit 206, among others.

In some embodiments, one or both of the controller 216 or the sump pressure control valve 218 of the sump pressurization system 200 can be included as part of the turbine engine 100. In some embodiments, a level of pressurization within one or more sumps of the plurality of sumps 186 of the turbine engine 100 may be varied independently of one or more other sumps of the plurality of sumps 186. For example, in some such embodiments, the turbine engine 100 can include two or more sump pressure control valves 218 corresponding to a number of sumps of the plurality of sumps 186 and the controller 216 can be configured to control each of the two or more sump pressure control valves 218 to independently control flow of inert gas to each of the plurality of sumps 186.

FIG. 5 is schematic diagram of the plurality of sumps 186 and the engine oil system 198 of the turbine engine 100 of FIG. 4, according to the present disclosure. As shown in FIG. 5, the engine oil system 198 of the turbine engine 100 includes an air-oil separator 220, a pump 222, and an oil tank 224. Particularly, sump vent air from the plurality of sumps 186 is provided to the air-oil separator 220 via a sump vent conduit 228. A scavenged oil-inert air mixture from the plurality of sumps 186 is provided to pump 222 via a sump scavenge conduit 230, which pumps the oil-inert air mixture to the air-oil separator 220. The air-oil separator 220 receives the sump vent air from the sumps 186, via the sump vent conduit 228, and the scavenged oil-inert air mixture from the sumps 186, via the sump scavenge conduit 230 and the pump 222, and separates oil from the inert air. Separated oil from the air-oil separator 220 is provided to the oil tank 224, which may be reused as lubrication oil for the sumps 186. Separated inert air from the air-oil separator 220 may be exhausted via the overboard vent line 214.

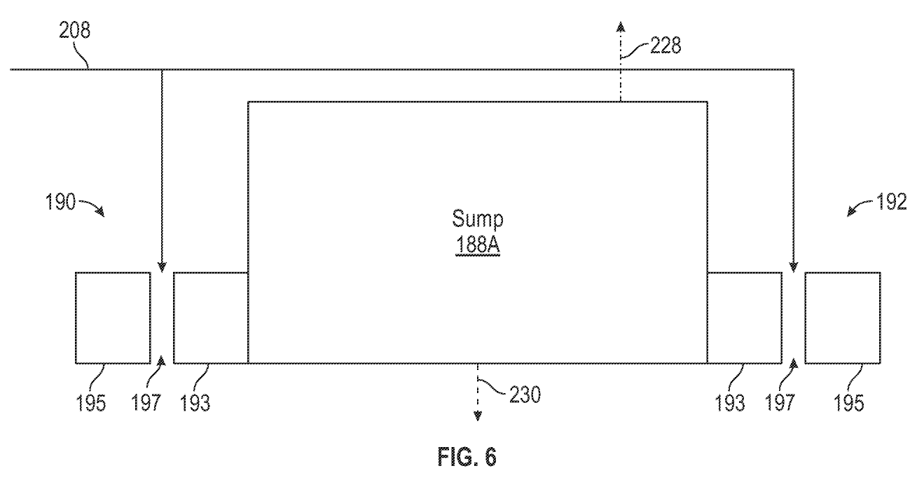

The plurality of sumps 186 of the turbine engine 100 includes a first sump 188A, a second sump 188B, a third sump 188C, and a fourth sump 188D. In other embodiments, the plurality of sumps 186 can include three or less or five or more sumps. FIG. 6 shows one sump 188A of the plurality of sumps 186 of FIG. 5 in more detail. The sump 188A of FIG. 6 is similar to the sump 188 as illustrated in FIG. 3. As shown in FIG. 6, each sump of the plurality of sumps 186 of the turbine engine 100 includes the first sump seal assembly 190 and the second sump seal assembly 192. Further, each of the first sump seal assembly 190 and the second sump seal assembly 192 includes the inner seal member 193 adjacent to the respective sump (e.g., sump 188A), the outer seal member 195 opposite the inner seal member 193, and the seal cavity buffer 197 defined between the inner seal member 193 and the outer seal member 195.

Referring again to FIG. 5, inert gas from the inert gas source 202 (FIG. 4) is provided, via the inert gas supply conduit 208, to the seal cavity buffer 197 of each of the first sump seal assembly 190 and the second sump seal assembly 192 (FIG. 6) of each sump of the plurality of sumps 186 of the turbine engine 100. Particularly, in the illustrated embodiment, the sump pressurization system 200 is configured to provide inert gas from the inert gas supply conduit 208 to each sump of the plurality of sumps 186 in parallel (i.e., inert gas from the inert gas source 202 flows along the inert gas supply conduit 208 and simultaneously to each sump of the plurality of sumps 186). In some embodiments, the sump pressurization system 200 may be configured to provide inert gas from the inert gas source 202 to each sump of the plurality of sumps 186 in series (i.e., inert gas from the inert gas source 202 flows along the inert gas supply conduit 208 and, then, in sequence to each sump of the plurality of sumps).

In some embodiments, the sump pressurization system 200 may be configured to provide inert gas from the inert gas source 202 directly to each sump of the plurality of sumps 186. For example, in some such embodiments, the sump pressurization system 200 can include two or more inert gas supply conduits 208 corresponding to a number of sumps of the plurality of sumps 186. In some such embodiments, the sump pressurization system 200 can include two or more inert gas sources 202 (e.g., configured as a plurality of refillable inert gas tanks) corresponding to a number of sumps of the plurality of sumps 186.

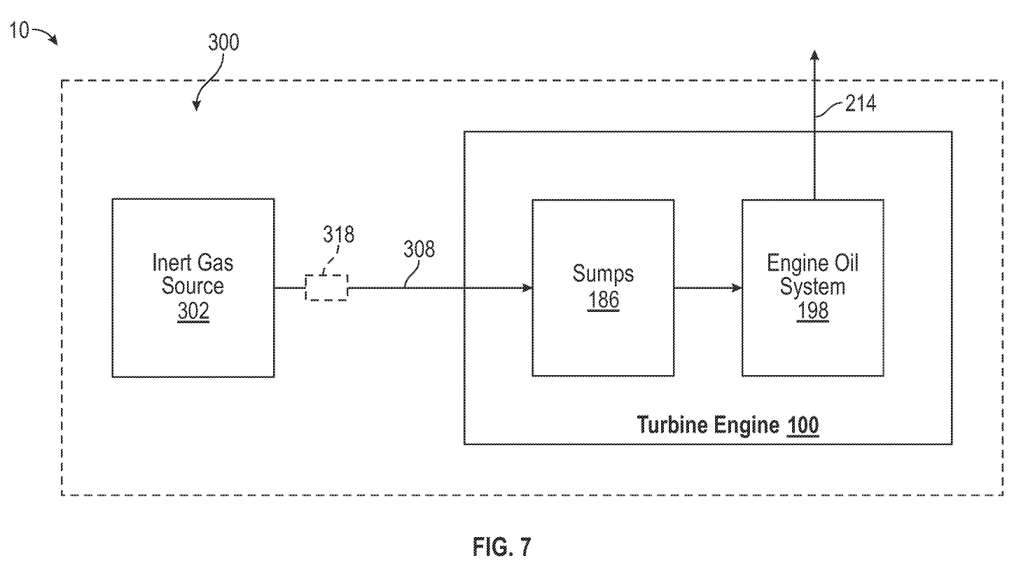

FIG. 7 is a schematic diagram of a sump pressurization system 300 of the aircraft 10 shown in FIG. 1 having the turbine engine 100 shown in FIGS. 1 to 5, according to another embodiment of the present disclosure. The sump pressurization system 300 is substantially similar to the sump pressurization system 200 of FIGS. 1 to 6. The same reference numerals or similar reference numerals will be used for components of the sump pressurization system 300 that are the same as, or similar to, the components of the sump pressurization system 200 discussed above with regard to FIGS. 1 to 6. The description of such components of the sump pressurization system 200 above also applies to these components of the sump pressurization system 300, and a detailed description of these components is omitted here.

Similar to the sump pressurization system 200 shown in FIGS. 1 to 6, the sump pressurization system 300 includes an inert gas source 302 that provides inert gas to the plurality of sumps 186 of the turbine engine 100 via an inert gas supply conduit 308. Flow of inert gas from the inert gas source 302 to the plurality of sumps 186 may be controlled via a sump pressure control valve 318 disposed along the inert gas supply conduit 308. The engine oil system 198 may vent reclaimed inert gas to atmosphere via the overboard vent line 214 of the turbine engine 100.

In the illustrated embodiment, inert gas source 302 of the sump pressurization system 300 is an inert gas tank that is filled with inert gas. For example, the inert gas source 302 may be filled with inert gas prior to takeoff of the aircraft 10. In some embodiments, the inert gas source 302 may include a plurality of inert gas tanks. For example, in some such embodiments, the inert gas source 302 can include at least two inert gas tanks that may be mounted to the wings 14 (FIG. 1) of the aircraft 10 adjacent to the respective turbine engines 100.

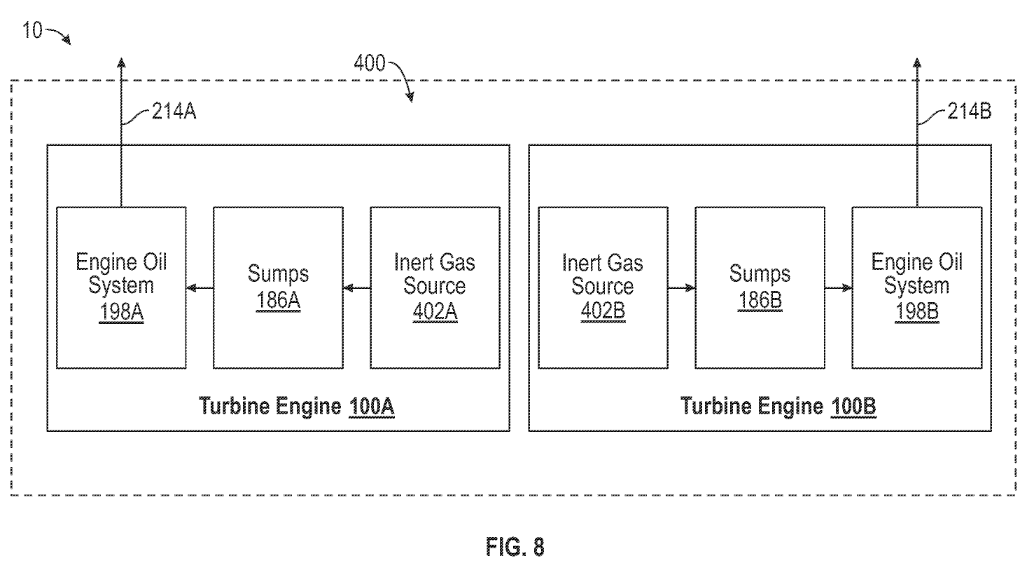

FIG. 8 is a schematic diagram of a sump pressurization system 400 of the aircraft 10 shown in FIG. 1 having the turbine engine 100 shown in FIGS. 1 to 5, according to another embodiment of the present disclosure. The sump pressurization system 400 is substantially similar to the sump pressurization system 200 of FIGS. 1 to 6. The same reference numerals or similar reference numerals will be used for components of the sump pressurization system 400 that are the same as, or similar to, the components of the sump pressurization system 200 discussed above with regard to FIGS. 1 to 6. The description of such components above of the sump pressurization system 200 also applies to these components of the sump pressurization system 400, and a detailed description of these components is omitted here.

In the illustrated embodiment, the sump pressurization system 400 includes a first inert gas source 402A of a first turbine engine 100A and a second inert gas source 402B of a second turbine engine 100B. The first turbine engine 100A and the second turbine engine 100B of FIG. 8 correspond to the turbine engines 100 of the aircraft 10 of FIG. 1. The first inert gas source 402A provides inert gas to a first plurality of sumps 186A of the first turbine engine 100A, and a first engine oil system 198A of the first turbine engine 100A may vent reclaimed inert gas to atmosphere via a first overboard vent line 214A of the first turbine engine 100A. Likewise, the second inert gas source 402B provides inert gas to a second plurality of sumps 186B of the second turbine engine 100B, and a second engine oil system 198B of the second turbine engine 100B may vent reclaimed inert gas to atmosphere via a second overboard vent line 214B of the second turbine engine 100B.

The first inert gas source 402A and the second inert gas source 402B of the sump pressurization system 400 are included as part of the respective first turbine engine 100A and the second turbine engine 100B. For example, in some embodiments, the first inert gas source 402A and the second inert gas source 402B may be inert gas tanks that are located within or mounted to the respective first turbine engine 100A and the second turbine engine 100B.

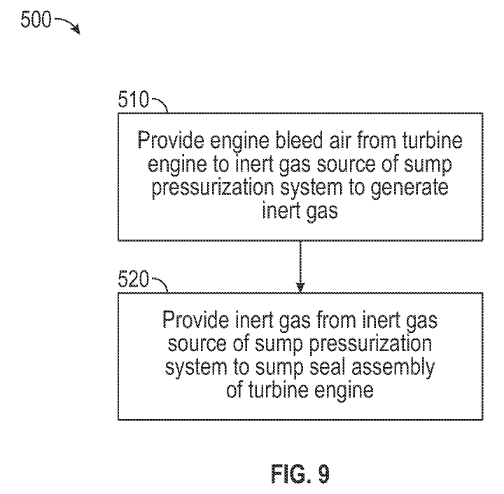

FIG. 9 is a flowchart showing a method 500 of pressurizing a sump of a turbine engine of an aircraft, such as the aircraft 10 of FIG. 1, according to the present disclosure. While reference is made to the aircraft 10 of FIG. 1 having the sump pressurization system 200 of FIGS. 1 to 6, the method 500 can be utilized with the sump pressurization systems 300 and 400 of FIGS. 7 and 8, or with any other sump pressurization system of any other aircraft.

In step 510, the method 500 includes providing engine bleed air from a turbine engine to an inert gas source of a sump pressurization system of an aircraft to generate inert gas. For example, with reference to the sump pressurization system 200 illustrated in FIG. 4, step 510 includes providing engine bleed air from the turbine engine 100, via the engine bleed conduit 206, to the inert gas source 202, which generates inert gas using the engine bleed air.

In step 520, the method 500 includes providing the inert gas, as generated in step 510, from the inert gas source to a sump seal assembly of the turbine engine. For example, with reference again to the sump pressurization system 200 illustrated in FIGS. 4 and 5, step 520 includes providing the inert gas from the inert gas source 202, via the inert gas supply conduit 208, to the first sump seal assemblies and the second sump seal assemblies of the plurality of sumps 186 of the turbine engine 100.

In some embodiments, step 510 and step 520 may be performed simultaneously. For example, with reference to the sump pressurization system 200 illustrated in FIG. 4, in some such embodiments, engine bleed air from the turbine engine 100 may be continuously provided to the inert gas source 202 and the inert gas source 202 may continuously provide inert gas to the plurality of sumps 186 of the turbine engine 100. In some embodiments, the method 500 may not include step 510. For example, with reference to the sump pressurization system 300 illustrated in FIG. 7, the inert gas source 202 may be an inert gas tank that is filled with inert gas such that engine bleed air is not required for the inert gas source 202 to provide inert gas.

Accordingly, the present disclosure provides for an improved sump pressurization system for an aircraft having at least one turbine engine that provides an inert gas to pressurize the sumps of the turbine engine and that can be operated to maintain sump pressurization throughout the various operating conditions of the turbine engine. Particularly, embodiments of the present disclosure can provide for a sump pressurization system that is not reliant on condition dependent engine bleeds, which can provide for a less complex turbine engine assembly with improved operational performance, and that utilizes an onboard inert gas source to pressurize the sumps of the turbine engine, which can extend the life of the lubrication oils used in the sumps of the turbine engine. This can enable the sump environment to run at higher temperatures and for longer durations with reduced oil degradation or coking deposits.

Further aspects of the present disclosure are provided by the subject matter of the following clauses.

A turbine engine for an aircraft includes a fan section including a fan, a turbo-engine operable with the fan section for driving the fan, a sump, a sump seal assembly that forms a sump seal between the sump and a void area of the turbine engine adjacent to the sump, and a sump pressurization system that includes an inert gas source that provides an inert gas. The sump pressurization system being arranged to route the inert gas from the inert gas source to one or both of the sump seal assembly or the void area to pressurize the sump.

The turbine engine of the preceding clause, the sump being defined by the turbo-engine, the fan section, or both.

The turbine engine of any preceding clause, the inert gas source providing the inert gas under positive pressure.

The turbine engine of any preceding clause, the turbo-engine including a compressor and defining a core air flow path therethrough, the inert gas source being not in fluid communication with the core air flow path.

The turbine engine of any preceding clause, the inert gas source being an inert gas generating system of the turbine engine.

The turbine engine of any preceding clause, the inert gas source being an inert gas tank of the turbine engine or the aircraft.

The turbine engine of any preceding clause, the inert gas source being an inert gas generating system of the aircraft or an inert gas tank of the aircraft.

The turbine engine of any preceding clause, the inert gas being one or more of nitrogen, carbon dioxide, helium, neon, argon, krypton, xenon, or radon.

The turbine engine of any preceding clause, the sump being a first sump and the sump seal assembly being a first sump seal assembly, the turbine engine further including a second sump and a second sump seal assembly.

The turbine engine of any preceding clause, the first sump being defined by the fan section and the second sump is defined by the turbo-engine.

The turbine engine of any preceding clause, the sump pressurization system providing inert gas to the first sump seal assembly and to the second sump seal assembly in parallel.

The turbine engine of any preceding clause, the sump being a first sump and the sump seal assembly being a first sump seal assembly, the turbine engine further including a second sump, a second sump seal assembly, a third sump, and a third sump seal assembly.

The turbine engine of any preceding clause, the sump pressurization system providing inert gas, in parallel, to the first sump seal assembly, the second sump seal assembly, and the third sump seal assembly.

The turbine engine of any preceding clause, at least one of the first sump, the second sump, or the third sump being defined by the fan section.

The turbine engine of any preceding clause, the sump pressurization system providing the inert gas to the sump seal assembly.

The turbine engine of any preceding clause, the sump seal assembly including a first seal member adjacent to the sump, a second seal member adjacent to the void area, and a seal cavity buffer defined between the first seal member and the second seal member, the sump pressurization system providing the inert gas to the seal cavity buffer.

The turbine engine of any preceding clause, the sump seal assembly being a first sump seal assembly that forms a first sump seal between the sump and a first void area of the turbine engine, the turbine engine further including a second sump seal assembly that forms a second sump seal between the sump and a second void area of the turbine engine, opposite the first void area, the sump pressurization system providing the inert gas to the first sump seal assembly and the second sump seal assembly.

The turbine engine of any preceding clause, the first sump seal assembly including a first seal member adjacent to the sump, a second seal member adjacent to the first void area, and a first seal cavity buffer defined between the first seal member and the second seal member.

The turbine engine of any preceding clause, the second sump seal assembly including a third seal member adjacent to the sump, a fourth seal member adjacent to the second void area, and a second seal cavity buffer defined between the third seal member and the fourth seal member.

The turbine engine of any preceding clause, the sump pressurization system providing the inert gas to the first seal cavity buffer of the first sump seal assembly and the second seal cavity buffer of the second sump seal assembly.

An aircraft includes a turbine engine, an inert gas source that provides an inert gas, and a sump pressurization system. The turbine engine includes a fan section including a fan and a turbo-engine operable with the fan section for driving the fan. The turbo-engine includes a compressor and defining a core air flow path therethrough, a sump, and a sump seal assembly that forms a sump seal between the sump and a void area of the turbine engine adjacent to the sump. The sump pressurization system being arranged to route the inert gas from the inert gas source to one or both of the sump seal assembly or the void area to pressurize the sump.

The aircraft of the preceding clause, the inert gas including one or more of nitrogen, carbon dioxide, helium, neon, argon, krypton, xenon, or radon.

The aircraft of any preceding clause, the sump being defined by at least one of the turbo-engine or the fan section.

The aircraft of any preceding clause, the inert gas source providing the inert gas under positive pressure to the sump pressurization system.

The aircraft of any preceding clause, the turbine engine being a first turbine engine, the sump is a first sump of the first turbine engine, and the sump seal assembly is a first sump seal assembly of the first turbine engine, and the aircraft further including a second turbine engine that includes a second sump and a second sump seal assembly, and the sump pressurization system providing the inert gas to the first sump seal assembly of the first turbine engine and to the second sump seal assembly of the second turbine engine.

The aircraft of any preceding clause, the inert gas source being an inert gas generating system of the aircraft or an inert gas tank of the aircraft.

The aircraft of any preceding clause, the sump being a first sump and the sump seal assembly is a first sump seal assembly, the turbine engine further including a second sump and a second sump seal assembly.

The aircraft of any preceding clause, the sump pressurization system providing inert gas to the first sump seal assembly and to the second sump seal assembly in parallel.

The aircraft of any preceding clause, the first sump being defined by the fan section and the second sump is defined by the turbo-engine.

The aircraft of any preceding clause, the sump being a first sump and the sump seal assembly is a first sump seal assembly, the turbine engine further including a second sump, a second sump seal assembly, a third sump, and a third sump seal assembly.

The aircraft of any preceding clause, the sump pressurization system providing inert gas, in parallel, to the first sump seal assembly, the second sump seal assembly, and the third sump seal assembly.

The aircraft of any preceding clause, at least one of the first sump, the second sump, or the third sump being defined by the fan section.

The aircraft of any preceding clause, the turbine engine including the inert gas source.

The aircraft of any preceding clause, the inert gas source being an inert gas generating system of the turbine engine.

The aircraft of any preceding clause, the inert gas source being not in fluid communication with the core air flow path of the turbine engine.

The aircraft of any preceding clause, the sump pressurization system providing the inert gas to the sump seal assembly.

The aircraft of any preceding clause, the sump seal assembly including a first seal member adjacent to the sump, a second seal member adjacent to the void area, and a seal cavity buffer defined between the first seal member and the second seal member, the sump pressurization system providing the inert gas to the seal cavity buffer.

The aircraft of any preceding clause, the sump seal assembly being a first sump seal assembly that forms a first sump seal between the sump and a first void area of the turbine engine, the turbine engine further including a second sump seal assembly that forms a second sump seal between the sump and a second void area of the turbine engine, opposite the first void area, the sump pressurization system providing the inert gas to the first sump seal assembly and the second sump seal assembly.

The aircraft of any preceding clause, the first sump seal assembly including a first seal member adjacent to the sump, a second seal member adjacent to the first void area, and a first seal cavity buffer defined between the first seal member and the second seal member.

The aircraft of any preceding clause, the second sump seal assembly including a third seal member adjacent to the sump, a fourth seal member adjacent to the second void area, and a second seal cavity buffer defined between the third seal member and the fourth seal member,

The aircraft of any preceding clause, the sump pressurization system providing the inert gas to the first seal cavity buffer of the first sump seal assembly and the second seal cavity buffer of the second sump seal assembly.

A method of pressurizing a sump of a turbine engine of an aircraft, the method including providing an inert gas from an inert gas source of a sump pressurization system of the aircraft to a sump seal assembly of the turbine engine that forms a sump seal between the sump and a void area of the turbine engine adjacent to the sump, the sump being defined by at least one of a turbo-engine or a fan section of the turbine engine.

The method of the preceding clause, the inert gas source being an inert gas generating system of the aircraft, and

The method of any preceding clause, the method further including providing engine bleed air from the turbine engine to the inert gas generating system to generate the inert gas.

The method of any preceding clause, the inert gas source being an inert gas tank of the aircraft.

Although the foregoing description is directed to the preferred embodiments, other variations and modifications will be apparent to those skilled in the art and may be made without departing from the disclosure. Moreover, features described in connection with one embodiment may be used in conjunction with other embodiments, even if not explicitly stated above.

1. A turbine engine for an aircraft, the turbine engine comprising:
a fan section comprising a fan;
a turbo-engine operable with the fan section for driving the fan, the turbo-engine comprising a compressor and defining a core air flow path therethrough;
a sump defined by at least one of the turbo-engine or the fan section;
a sump seal assembly that forms a sump seal between the sump and a void area of the turbine engine adjacent to the sump; and
a sump pressurization system comprising an inert gas source that provides an inert gas under positive pressure, the sump pressurization system being arranged to route the inert gas from the inert gas source to one or both of the sump seal assembly or the void area to pressurize the sump.

2. The turbine engine of claim 1, wherein the inert gas source is an inert gas generating system (IGGS) of the turbine engine.

3. The turbine engine of claim 1, wherein the inert gas source is an inert gas generating system (IGGS) of the aircraft or an inert gas tank of the aircraft.

4. The turbine engine of claim 1, wherein the inert gas source is not in fluid communication with the core air flow path of the turbine engine.

5. The turbine engine of claim 1, wherein the inert gas comprises one or more of nitrogen, carbon dioxide, helium, neon, argon, krypton, xenon, or radon.

6. The turbine engine of claim 1, wherein the sump is a first sump and the sump seal assembly is a first sump seal assembly, the turbine engine further comprising a second sump and a second sump seal assembly.

7. The turbine engine of claim 6, wherein the sump pressurization system provides inert gas to the first sump seal assembly and to the second sump seal assembly in parallel.

8. The turbine engine of claim 6, wherein the first sump is defined by the fan section and the second sump is defined by the turbo-engine.

9. The turbine engine of claim 1, wherein the sump is a first sump and the sump seal assembly is a first sump seal assembly, the turbine engine further comprising a second sump, a second sump seal assembly, a third sump, and a third sump seal assembly.

10. The turbine engine of claim 9, wherein the sump pressurization system provides inert gas, in parallel, to the first sump seal assembly, the second sump seal assembly, and the third sump seal assembly.

11. The turbine engine of claim 9, wherein at least one of the first sump, the second sump, or the third sump is defined by the fan section.

12. The turbine engine of claim 1, wherein the sump pressurization system provides the inert gas to the sump seal assembly.

13. The turbine engine of claim 12, wherein the sump seal assembly comprises a first seal member adjacent to the sump, a second seal member adjacent to the void area, and a seal cavity buffer defined between the first seal member and the second seal member, the sump pressurization system providing the inert gas to the seal cavity buffer.

14. The turbine engine of claim 12, wherein the sump seal assembly is a first sump seal assembly that forms a first sump seal between the sump and a first void area of the turbine engine, the turbine engine further comprising a second sump seal assembly that forms a second sump seal between the sump and a second void area of the turbine engine, opposite the first void area, the sump pressurization system providing the inert gas to the first sump seal assembly and the second sump seal assembly.

15. The turbine engine of claim 14, wherein the first sump seal assembly comprises a first seal member adjacent to the sump, a second seal member adjacent to the first void area, and a first seal cavity buffer defined between the first seal member and the second seal member,
wherein the second sump seal assembly comprises a third seal member adjacent to the sump, a fourth seal member adjacent to the second void area, and a second seal cavity buffer defined between the third seal member and the fourth seal member, and
wherein the sump pressurization system provides the inert gas to the first seal cavity buffer of the first sump seal assembly and the second seal cavity buffer of the second sump seal assembly.

16. An aircraft comprising:
a turbine engine comprising:
a fan section comprising a fan;
a turbo-engine operable with the fan section for driving the fan, the turbo-engine comprising a compressor and defining a core air flow path therethrough;
a sump defined by at least one of the turbo-engine or the fan section; and
a sump seal assembly that forms a sump seal between the sump and a void area of the turbine engine adjacent to the sump;
an inert gas source that provides an inert gas under positive pressure, the inert gas source being an inert gas generating system (IGGS) of the aircraft, an inert gas tank of the aircraft, or both; and
a sump pressurization system in fluid communication with the inert gas source and being arranged to route inert gas from the inert gas source to one or both of the sump seal assembly or the void area to pressurize the sump of the turbine engine.

17. The aircraft of claim 16, wherein the inert gas comprises one or more of nitrogen, carbon dioxide, helium, neon, argon, krypton, xenon, or radon.

18. The aircraft of claim 16, wherein the turbine engine is a first turbine engine, the sump is a first sump of the first turbine engine, and the sump seal assembly is a first sump seal assembly of the first turbine engine, and the aircraft further comprising a second turbine engine that comprises a second sump and a second sump seal assembly, and
wherein the sump pressurization system provides the inert gas to the first sump seal assembly of the first turbine engine and to the second sump seal assembly of the second turbine engine.

19. The aircraft of claim 16, wherein the sump pressurization system provides the inert gas to the sump seal assembly of the turbine engine.

20. The aircraft of claim 19, wherein the sump seal assembly of the turbine engine comprises a first seal member adjacent to the sump, a second seal member adjacent to the void area, and a seal cavity buffer defined between the first seal member and the second seal member, the sump pressurization system providing the inert gas to the seal cavity buffer.
